(19) United States
(12) Patent Application Publication
(10) Pub. No.: US 2026/0112000 A1
(43) Pub. Date: Apr. 23, 2026

(54) METHOD PERFORMED BY ELECTRONIC APPARATUS AND ELECTRONIC APPARATUS

(71) Applicant: SAMSUNG ELECTRONICS CO., LTD., Suwon-si (KR)

(72) Inventors: Jianxing ZHANG, Beijing (CN); Xiaoxia XING, Beijing (CN); Chunmiao LI, Beijing (CN)

(73) Assignee: SAMSUNG ELECTRONICS CO., LTD., Suwon-si (KR)

(21) Appl. No.: 19/202,500

(22) Filed: May 8, 2025

Related U.S. Application Data
(63) Continuation of application No. PCT/KR2025/004034, filed on Mar. 28, 2025.

(30) Foreign Application Priority Data
Oct. 23, 2024 (CN) 202411487735.1

(51) Int. Cl. G06T 5/50; G06T 5/60; G06T 7/50; G06T 7/60; G06T 7/73; G06V 10/54; G06V 10/56; G06V 10/762; G06V 10/82; G06V 40/16

(52) U.S. Cl. CPC G06T 5/50; G06T 5/60; G06T 7/50; G06T 7/60; G06T 7/73; G06V 10/54; G06V 10/762; G06V 10/82; G06V 40/168; G06T 2207/20084; G06T 2207/30201; G06V 10/56; G06V 40/174

(57) ABSTRACT

The disclosure provides an electronic apparatus and a method performed by the electronic apparatus. The method includes obtaining a first face image of a subject, which is a high-quality reference face image of the subject; obtaining a second face image of the subject based on the first face image of the subject, the second face image including neutral facial features for each part of a face of the subject; when obtaining a third face image, which is a degraded face image of the subject, obtaining one or more personalized facial features of the subject based on the first face image, the second face image and a third face image of the subject; and performing image restoration on the third face image based on the one or more personalized facial features to obtain a fourth face image corresponding to the third face image.

### CROSS-REFERENCE TO RELATED APPLICATION

This application is a bypass continuation of International Application No. PCT/KR2025/004034, filed on Mar. 28, 2025, which is based on and claims priority to Chinese Patent Application No. 202411487735.1 filed on Oct. 23, 2024, in the China National Intellectual Property Administration, the entire disclosures of which are incorporated herein by reference for all purposes.

### TECHNICAL FIELD

The disclosure relates to a field of artificial intelligence, and specifically to an image processing method performed by an electronic apparatus, the electronic apparatus, a computer readable storage medium and a computer program product.

### BACKGROUND

With the development of electronic technologies, electronic apparatuses (such as cell phones) are becoming more powerful in terms of imaging capabilities. However, the electronic apparatuses, due to a limitation of a physical size of hardware, suffer from a sharp degradation of a photo quality in some scenarios, such as high magnification zoom photography, low light conditions, or moving objects, and thus cannot meet image or photo quality requirements of users.

Electronic apparatus manufacturers have conducted a lot of research in improving an image quality, for example, designed artificial intelligence (AI)-based image quality enhancement algorithms. However, there is still room for improving the image quality in scenarios that cause serious degradation of the image quality.

### SUMMARY

According to an aspect of the disclosure, there is provided a method performed by an electronic apparatus, including: obtaining a first face image of a subject, which is a high-quality reference face image of the subject with image quality higher than a threshold value; obtaining a second face image of the subject based on the first face image of the subject, the second face image comprising neutral facial features for each part of a face of the subject; when obtaining a third face image, which is a degraded face image of the subject with image quality lower than the threshold value, obtaining one or more personalized facial features of the subject based on the first face image, the second face image and a third face image of the subject; performing image restoration on the third face image based on the one or more personalized facial features to obtain a fourth face image corresponding to the third face image; and outputting the fourth face image corresponding to the third face image.

According to an aspect of the disclosure, there is provided a method performed by an electronic apparatus, including: obtaining an artifact image corresponding to a first face image of a subject; performing degradation on the artifact image to obtain negative samples associated with the first face image; obtaining positive samples associated with the first face image based on a second face image of the subject; and performing image restoration on the first face image based on the negative samples and the positive samples to obtain a third face image corresponding to the first face image.

According to an aspect of the disclosure, there is provided a method performed by an electronic apparatus including: obtaining reconstructed features of a first face image of a subject based on the first face image; obtaining, based on the reconstructed features, decoded features of the first face image; performing texture correction on the decoded features based on one or more first facial features of the subject to obtain a texture corrected decoded features; and obtaining a second face image corresponding to the second face image based on the texture corrected decoded features.

According to an aspect of the disclosure, there is provided an electronic apparatus including: at least one processor; at least one memory storing computer executable instructions; wherein the computer executable instructions, when run by the at least one processor, cause the at least one processor to obtain a first face image of a subject, which is a high-quality reference face image of the subject with image quality higher than a threshold value, obtain a second face image of the subject based on the first face image of the subject, the second face image comprising neutral facial features for each part of a face of the subject, when obtaining a third face image, which is a degraded face image of the subject with image quality lower than the threshold value, obtain one or more personalized facial features of the subject based on the first face image, the second face image and a third face image of the subject, perform image restoration on the third face image based on the one or more personalized facial features to obtain a fourth face image corresponding to the third face image, and output the fourth face image corresponding to the third face image.

According to an aspect of the disclosure, there is provided a computer readable storage medium storing instructions that, when executed by at least one processor, cause the at least one processor to perform a method including obtaining a first face image of a subject, which is a high-quality reference face image of the subject with image quality higher than a threshold value; obtaining a second face image of the subject based on the first face image of the subject, the second face image comprising neutral facial features for each part of a face of the subject; when obtaining a third face image, which is a degraded face image of the subject with image quality lower than the threshold value, obtaining one or more personalized facial features of the subject based on the first face image, the second face image and a third face image of the subject; performing image restoration on the third face image based on the one or more personalized facial features to obtain a fourth face image corresponding to the third face image; and outputting the fourth face image corresponding to the third face image.

It should be understood that the above general description and the detailed descriptions that follow are merely exemplary and explanatory and do not limit the disclosure.

### BRIEF DESCRIPTION OF DRAWINGS

The accompanying drawings herein are incorporated into and form part of the specification, illustrate example embodiments consistent with the disclosure, which are used in conjunction with the specification to explain the principles of the disclosure and do not constitute an undue limitation of the disclosure.

FIG. 1 is a flowchart of a method performed by an electronic apparatus according to an exemplary embodiment of the disclosure.

FIG. 2 is a schematic diagram illustrating a method of generating a second face image according to an exemplary embodiment of the disclosure.

FIG. 3 is a schematic diagram illustrating a method of generating enhanced features according to an exemplary embodiment of the disclosure.

FIG. 4 is a schematic diagram illustrating a method of obtaining first facial features according to an exemplary embodiment of the disclosure.

FIG. 5 is a schematic diagram illustrating a method of obtaining personalized facial features of a user based on a third face image and a first face image according to an exemplary embodiment of the disclosure.

FIG. 6 is a schematic diagram illustrating a method of generating negative samples according to an exemplary embodiment of the disclosure.

FIG. 7 is a schematic diagram of a distorted face generator according to an exemplary embodiment of the disclosure.

FIG. 8 is a schematic diagram illustrating a method of modulating decoded features according to an exemplary embodiment of the disclosure.

FIG. 9 is a diagram of an overall architecture for face image restoration according to an exemplary embodiment of the disclosure.

FIG. 10 is a schematic diagram illustrating a method of face image restoration according to an exemplary embodiment of the disclosure.

FIG. 11 is a flowchart of a method performed by an electronic apparatus according to another exemplary embodiment of the disclosure.

FIG. 12 is a flowchart of a method performed by an electronic apparatus according to yet another exemplary embodiment of the disclosure.

FIG. 13 is a block diagram illustrating an electronic apparatus according to exemplary embodiments of the disclosure.

FIG. 14 illustrates a schematic diagram of a structure of an electronic apparatus applicable to embodiments of the disclosure.

### DETAILED DESCRIPTION

The following description with reference to the accompanying drawings is provided to aid in a thorough understanding of various embodiments of the disclosure as defined by claims and equivalents thereof. This description includes various specific details to aid in understanding but should only be considered exemplary. Accordingly, those ordinary skills in the art will recognize that various changes and modifications can be made to the various embodiments described herein without departing from the scope and spirit of the disclosure. In addition, descriptions of well-known features and structures may be omitted for the sake of clarity and brevity.

The terms and phrases used in the claims and the following description are not limited to dictionary meaning thereof, but are used only by the inventor to enable a clear and consistent understanding of the disclosure. Accordingly, it should be apparent to those skilled in the art that, the following description of the various embodiments of the disclosure is provided for an illustrative purpose only and is not intended to a purpose of limiting the disclosure as defined by the appended claims and equivalents thereof.

It should be understood that, “a”, “an” and “the” in a singular form may also include a plural reference, unless the context clearly indicates otherwise. Thus, for example, a reference to a “part surface” includes a reference to one or more such surfaces. When it refers to one element as being “connected” or “coupled” to another element, the one element may be directly connected or coupled to the other element, or it may refer to a connection relationship between the one element and the other element established through an intermediate element. In addition, “connected” or “coupled” as used herein may include wirelessly connected or wirelessly coupled.

The term “include” or “may include” refers to the presence of a function, operation, or component of the corresponding disclosure that may be used in the various embodiments of the disclosure, and does not limit the presence of one or more additional functions, operations, or features. In addition, the terms “include” or “have” may be interpreted to denote certain features, figures, steps, operations, constituent elements, components, or combinations thereof, but should not be interpreted to exclude the possibility of the presence of one or more other features, figures, steps, operations, constituent elements, components, or combinations thereof.

The term “or” as used in the various embodiments of the disclosure includes any of the listed terms and all combinations thereof. For example, “A or B” may include A, may include B, or may include both A and B. When describing a plurality of (two or more) items, the plurality of items may refer to one, more, or all of the plurality of items if a relationship among the plurality of items is not explicitly defined. For example, for the description “a parameter A comprises A1, A2, A3”, it may be implemented as parameter A comprising A1, A2 or A3, or as parameter A comprising at least two of the three items of the parameter A1, A2, A3.

All terms (including technical or scientific terms) used in the disclosure have the same meaning as understood by those skilled in the art to which the disclosure belongs, unless defined differently. Common terms as defined in dictionaries are interpreted to have a meaning consistent with the context in the relevant technology art and should not be interpreted in an idealized or overly formalistic manner, unless expressly so defined in the disclosure.

According to one or more embodiments, a “module” or a “˜er/or” may perform at least one function or operation, and be implemented by hardware, software, or a combination of hardware and software. In addition, a plurality of “modules” or a plurality of “˜ers/ors” may be integrated with each other in at least one module and implemented by at least one processor except for a “module”or an “˜er/or”that needs to be implemented in specific hardware.

At least part of the functions in a device or electronic apparatus provided in the embodiments of the disclosure may be implemented through an AI model, such as, at least one of a plurality of modules of the device or electronic apparatus may be implemented through the AI model. A function associated with AI may be performed through the non-volatile memory, the volatile memory, and the processor.

The processor may include one or more processors. At this time, the one or more processors may be a general purpose processor, such as a central processing unit (CPU), an application processor (AP), or the like, or may be a graphics-only processing unit such as a graphics processing unit (GPU), a visual processing unit (VPU), and/or an AI-dedicated processor such as a neural processing unit (NPU).

The one or more processors control processing of input data in accordance with a predefined operating rule or artificial intelligence (AI) model stored in the non-volatile memory and the volatile memory. The predefined operating rule or artificial intelligence model is provided through training or learning.

Here, being provided through learning means that, by applying a learning algorithm to a plurality of learning data, a predefined operating rule or an AI model of a desired characteristic is made. The learning may be performed in a device or electronic apparatus itself in which AI according to one or more embodiments is performed, and/or may be implemented through a separate server/system.

The AI model may include a plurality of neural network layers. Each layer has a plurality of weight values, and performs a neural network calculation by calculating between the input data of this layer (such as, a calculation result of the previous layer and/or the input data of the AI model) and the plurality of weight values of the current layer. Examples of neural networks include, but are not limited to, a convolutional neural network (CNN), a deep neural network (DNN), a recurrent neural network (RNN), a restricted Boltzmann Machine (RBM), a deep belief network (DBN), a bidirectional recurrent deep neural network (BRDNN), a generative adversarial networks (GAN), and a deep Q-network.

The learning algorithm is a method for training a predetermined target device (for example, a robot) using a plurality of learning data to cause, allow, or control the target device to make a determination or prediction. Examples of the learning algorithm include, but are not limited to, supervised learning, unsupervised learning, semi-supervised learning, or reinforcement learning.

According to one or more embodiments, methods provided in the disclosure may involve or may be implemented in one or more of technical fields including, but not limited to, speech, language, image, video, or data intelligence.

According to an embodiment, in the method executed by electronic apparatus involving the field of speech or language, a speech signal, which is an analog signal, may be received via speech input devices (e.g., a microphone), and the speech part is converted into computer readable text using an automatic speech recognition (ASR) model. The intent of utterance by a user may be obtained by interpreting the converted text using a natural language understanding (NLU) model. The ASR model or NLU model may be an artificial intelligence model. The artificial intelligence model may be processed by an artificial intelligence-dedicated processor designed in a hardware structure specified for artificial intelligence model processing. Language understanding is a technique for recognizing and applying/processing human language/text. The language understanding may include, but is not limited to, natural language processing, machine translation, dialog system, question answering, or speech recognition/synthesis.

According to an embodiment, in the method executed by electronic apparatus involving the field of image or video, output data may be obtained by using image data as input data for an artificial intelligence model. According to an embodiment, the method executed by electronic apparatus may involve the field of visual understanding in the artificial intelligence technology. For example, visual understanding is a technique for recognizing and processing things as does human vision and includes, e.g., object recognition, object tracking, image retrieval, human recognition, scene recognition, 3D reconstruction/localization, or image enhancement.

According to one or more embodiments, in the method executed by electronic apparatus involving the field of data intelligence processing, in the reasoning or predicting stage, an artificial intelligence model can be used to perform predictions by using real-time input data. Processors of the electronic apparatus may perform a pre-processing operation on the data to convert into a form appropriate for use as an input for the artificial intelligence model. Reasoning and prediction is a technique of logically reasoning and predicting by determining information and includes, e.g., knowledge-based reasoning, optimization prediction, preference-based planning, or recommendation.

According to one or more embodiments of the disclosure, the artificial intelligence model may be obtained by training. Here, “obtained by training” means that a predefined operation rule or artificial intelligence model configured to perform a desired feature (or purpose) is obtained by training a basic artificial intelligence model with multiple pieces of training data by a training algorithm. The artificial intelligence model may include a plurality of neural network layers. Each of the plurality of neural network layers includes a plurality of weight values and performs neural network computation by computation between a result of computation by a previous layer and the plurality of weight values.

A “face restoration” (also known as “face redrawing” or “face hallucination”) technology is an important branch of an image quality enhancement technology, which is a technology that specializes in improving an image quality of a human face region. This improvement includes, but is not limited to, restoring and generating details (e.g., interpolating a finer texture for a region with a fuzzy texture, and generating a semantically reasonable, realistic, and natural texture for a region without a texture), reducing an image noise, and eliminating blurring to make the image clear, etc.

Related art schemes used for face restoration generally include two major categories. A first category is a scheme based on adversarial generative networks. However, due to a limited model capacity of a generator (CNN-based or Transformer-based), the scheme based on adversarial generative networks still fails to obtain user-satisfying results in some extreme scenarios. A second category is an AI-based cloud model scheme, which uses multiple frames of images with different exposure times as inputs to the model, with the aim of exploiting complementary information between the frames. This approach still fails to obtain satisfactory results for users in some scenarios, such as long-distance zooming (10×-100×), because a sensor captures very little information due to the long distance, and increasing the exposure time provides no significant benefit.

In general, for severely degraded face restoration, human visual assessment involves two basic aspects: (1) whether the pre-restoration face and the post-restoration face belong to the same person, e.g., how is fidelity of the restoration; and (2) whether the restored texture is natural and free of artifacts. However, in both of the aspects, the related art schemes have problems.

For example, due to hardware physical limitations, in some cases (e.g., high magnification zooming), the sensor can capture relatively less effective image information and lack identifiable texture structure information. Even so, a process of eliminating degradation in the related art scheme may further remove some of the beneficial structural and textural information, resulting in a further reduction of effective identity (ID) features, thereby reducing the fidelity of the restored face image.

In another example, the face image restored using the related art scheme may suffer from characteristic artifacts. The characteristic artifacts are unrealistic, unreasonable, and unnatural textures produced by neural network, such as hair on face. The reasons for appearance of the characteristic artifacts are (1) if the degradation elimination is not satisfactory, some inappropriate textures may remain. These inappropriate textures may introduce unexpected artifacts in the texture generation stage; (2) in the case of using a diffusion model, the restored information will have unwanted artifacts due to stochasticity.

A diffusion technology based on the diffusion model is a related art technology used for a variety of visual tasks. However, at least one of the following problems may occur when using the diffusion technology to improve extremely degraded face images: (1) the restored face images lack fidelity; and (2) artifacts may be generated. Extreme degradation mainly refers to a serious loss of effective information in a face image, such as a face image captured using a high magnification zoom. The information may be lost due to hardware limitations, object motion, or insufficient illumination.

According to one or more example embodiments of the disclosure, there is provided a scheme for restoring an extremely degraded low-quality face image with high fidelity. Below, technical solutions of the disclosure and the technical effects produced by the technical solutions of the disclosure will be explained by describing one or more example embodiments. It should be noted that, the following embodiments may be referred to, imitated or combined with each other, and the same term, similar features and similar implementation operations in different embodiments will not be described repeatedly.

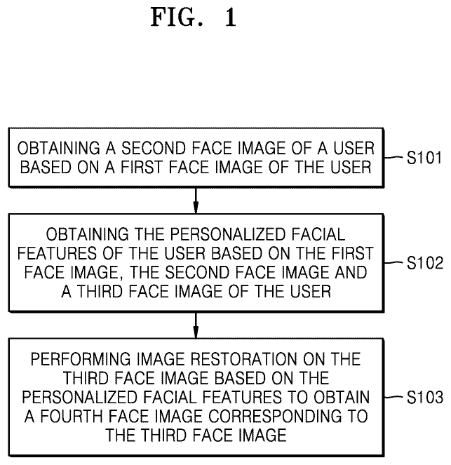

FIG. 1 is a flowchart of a method performed by an electronic apparatus according to an exemplary embodiment of the disclosure.

Referring to FIG. 1, at operation S101, a second face image of a user is obtained based on a first face image of the user. For example, the second face image represents a face image that does not include personalized facial features of the user. The personalized facial features may be understood as facial features that can represent the user and have identifiable and distinguishing features.

The first face image may be a clear, high-quality face image belonging to the same user as a face image to be restored (which may be referred to as a third face image). The first face image may be a high-quality face image of the subject with image quality higher than a threshold value. For example, the first face image may have a resolution greater than the threshold value. The third face image may be a low-quality face image of the subject with image quality lower than the threshold value. For example, the third face image may be a degraded face image (e.g., extremely degraded face image) captured using a high magnification zoom. The first face image may be a high-quality reference face image of the same user.

According to one or more embodiments of the disclosure, the second face image may also be referred to as a neutral face image, a standard face image or an average face. The second face image may be generated based on a pre-established face part library. The face part library may be a database including at least one clustering center for each part of a face. Each clustering center may be obtained from face images of a plurality of sample users using a clustering algorithm.

For example, for each face region in the first face image, at least one clustering center corresponding to the face region is selected from the face part library, a feature of the face region is obtained based on the at least one clustering center, and the second face image is obtained based on the features of the individual face regions. For example, the feature of the face region may obtained by performing a cascade or an averaging of the at least one clustering center.

According to one or more embodiments, the first face image may be transformed into a first geometric structure feature corresponding to a set direction. According to an embodiment, a feature may be determined for each part of a face corresponding to the first geometric structure feature. For example, a feature of each of the parts of the face may be determined based on the pre-established face part library, and the second face image may be obtained based on the feature of each of the parts of the face.

For example, a three-dimensional (3D) geometric structure feature in the first face image may be transformed into a first geometric structure feature corresponding to a forward face direction (e.g., set direction) based on a pose feature in the first face image, and for each part of the forward face corresponding to the first geometric structure feature, n clustering centers may be determined from the pre-established face part library, wherein where n is a positive integer greater than or equal to 1. For example, a feature for each of the parts may be obtained using a first attention network based on each of the parts and the n clustering centers for each of the parts, and the second face image may be obtained based on the feature for each of the parts.

According to an embodiment, for each part of the forward face corresponding to the first geometric structure feature, the method may include using a feature of the respective part in the first geometric structure feature as a first query vector of the first attention network, extracting a first key vector and a first value vector of the first attention network from each of the n clustering centers of the part, obtaining n intermediate features using the first attention network based on the first query vector, the first key vector and the first value vector respectively corresponding to each of the n clustering centers, and obtaining a feature of the part in the forward face by performing feature fusion on the n intermediate features.

While example embodiments illustrated above may be based on the direction being set the forward face direction, the set direction of the disclosure is not limited thereto, and as such, according to another embodiment, the set direction may be a different face direction.

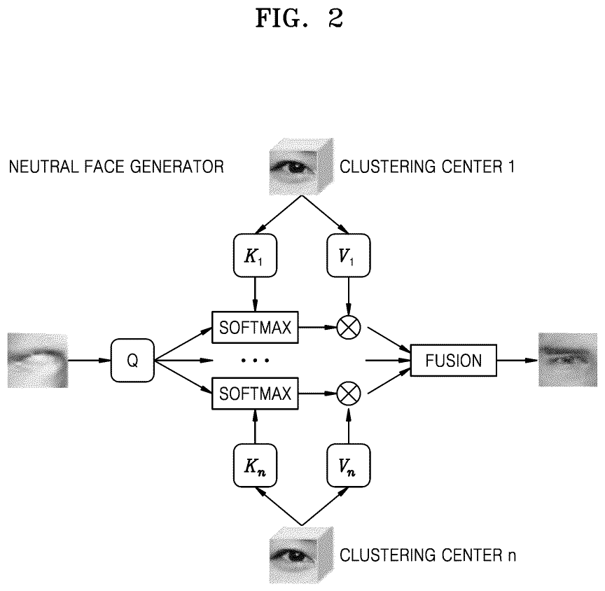

FIG. 2 is a schematic diagram illustrating a method of generating a second face image according to an exemplary embodiment of the disclosure. A neutral face generator (which may also be referred to as a standard face generator or an average face generator) of the disclosure may be used to obtain the second face image. The neutral face generator may be formed by an attention network and may include a face part library that is a library of standard face parts pre-established for each part of a face. The parts of the face may include, but is not limited to, left and right eyes, nose, mouth, and skin.

For example, for a forward face corresponding to the first face image, n nearest clustering centers are searched for each part of the forward face, and the clustering centers of the each part are weighted and fused to obtain a neutral face feature for the each part. An eye in the forward face is described below as an example.

According to an embodiment, based on a pose feature in the first face image, by transforming a 3D geometric structure feature in the first face image into a first geometric structure feature corresponding to the forward face direction, each part of the forward face corresponding to the first geometric structure feature is obtained. As shown in FIG. 2, for an eye part, the method may include searching for n nearest clustering centers from the face part library, extracting a first key vector and a first value vector from each of the clustering centers, and using a feature of the eye part in the first geometric structure feature as a first query vector. For example, a first key vector K₁ and a first value vector V₁ may be extracted from a clustering center 1, and the feature of the eye part in the first geometric structure feature may be used as the first query vector Q. A softmax function operation may be performed based on the Q and the K₁, and a result of the operation may be multiplied with the V₁ to obtain an intermediate feature for the clustering center 1. For each clustering center, the operation is performed in the above manner, n intermediate features may be obtained, and the n intermediate features are fused based on a similarity to obtain a neutral face feature of the eye part. The above operations are only exemplary, and the disclosure is not limited thereto.

By correcting the first face image to a standard pose (e.g., a forward pose), facial features of the user may be better extracted. Furthermore, considering the diversity of neutral face features corresponding to various parts of the face, the neutral face feature corresponding to each part is obtained by determining a plurality of similar neutral face features for each part from the face part library, and fusing the plurality of similar neutral face features based on the similarity, so as to achieve accurate extraction of features of various parts of the face of the user.

Referring to FIG. 1, at operation S102, the personalized facial features of the user are obtained based on the first face image, the second face image, and the third face image of the user.

Facial features of the user may include, but is not limited to, at least one of a brightness feature, a color feature, an expression feature, a pose feature, a 3D geometric structure feature, a texture feature, and the like of the face.

For example, the brightness feature and the color feature of the face may be separate features, and the expression feature, the pose feature, the 3D geometric structure feature, and the texture feature may not include a color attribute.

The expression feature may be a feature used to represent a facial expression and does not include a spatial geometry attribute. For example, the facial feature may include, but is not limited to, a smile or a frown.

The pose feature may be a feature used to represent the face in a 3D space, and three angles used to characterize the pose feature may include, but is not limited to, a pitch angle, a yaw angle, and a roll angle.

The 3D geometric structure feature may be a feature used to represent a geometric structure of the face. For example, the geometric structure of the face may include, but is not limited to, a contour of the face, a height of a nose, a prominence of a cheekbones, etc.

The texture feature may include, but is not limited to, a coarse texture feature, a fine texture feature and a personalized feature. For example, the coarse texture feature may include a boundary texture feature of a face part, such as a shape of a corner of an eye and a lip line. The fine texture feature may include fine-grained texture features, such as hair, pores, and other texture details. The personalized feature may include unique markings such as moles, wrinkles, scars, and the like.

The above features may constitute an identity of the user such that the user is visually recognizable and distinguishable from other users.

As an example, first facial features of the user are obtained based on the first face image, the second face image and the third face image, and the personalized facial features of the user are obtained based on the first facial features and second facial features extracted from the third face image. For example, the first facial features may include at least one of the 3D geometric structure feature and the texture feature of the face. The second facial features may include at least one of the brightness feature, the color feature, the expression feature and the pose feature of the face.

As an example, the first face image, the second face image and the third face image may be input to a neural network to obtain the first facial features of the user. As another example, the second face image, the third face image and the pose feature, the 3D geometric structure feature and the texture feature of the face contained in the first face image may be input to a neural network to obtain the first facial features of the user.

A facial feature extractor based on a neural network may be used to perform a feature extraction process. For example, at least one of the brightness feature, the color feature, the expression feature, the pose feature, the 3D geometric structure feature and the texture feature of the face may be extracted from the third face image using the facial feature extractor. At least one of the brightness feature, the color feature, the expression feature, the pose feature, the 3D geometric structure feature and the texture feature of the face may be extracted from the first face image using the facial feature extractor. The facial feature extractor for extracting the face features of the third face image and the facial feature extractor for extracting the facial features of the first face image may be the same or different. In different cases, the facial feature extractor for extracting the facial features of the third face image and the facial feature extractor for extracting the facial features of the first face image may share weights.

As an example, the facial features may be extracted from the third face image and the first face image, respectively, and the personalized facial features of the user may be obtained by processing the extracted facial features. For example, the personalized facial features of the user may be obtained by fusing the extracted facial features.

According to one or more embodiments of the disclosure, the brightness feature, the color feature, the expression feature and the pose feature of the face may be consistent with the third face image, and the 3D geometric structure feature and the texture feature of the face may be enhanced by referring to the first face image, which ensures that the user is accurately identified and avoids altering the appearance of the user during a feature enhancement process.

According to one or more embodiments of the disclosure, the first face image may be transformed into a first geometric structure feature corresponding to a set direction, and, based on the first geometric structure feature and the texture feature in the first face image, a face image with the texture feature is obtained, enhanced features of the user are obtained based on the face image and the second face image, and the first facial features are obtained based on the enhanced features and the texture feature and the 3D geometric structure feature in the third face image.

As an example, the 3D geometric structure feature in the first face image may be transformed into a first geometric structure feature corresponding to a forward face direction based on the pose feature in the first face image, a forward face image with the texture feature may be obtained based on the first geometric structure feature and the texture feature in the first face image, the enhanced features of the user may be obtained based on the forward face image and the second face image, the first facial feature of the user may be obtained based on the enhanced features and the texture feature and the 3D geometric structure feature in the third face image. Here, the enhanced features may include at least one of the 3D geometric structure feature and the texture feature, or may include the personalized feature in the texture feature.

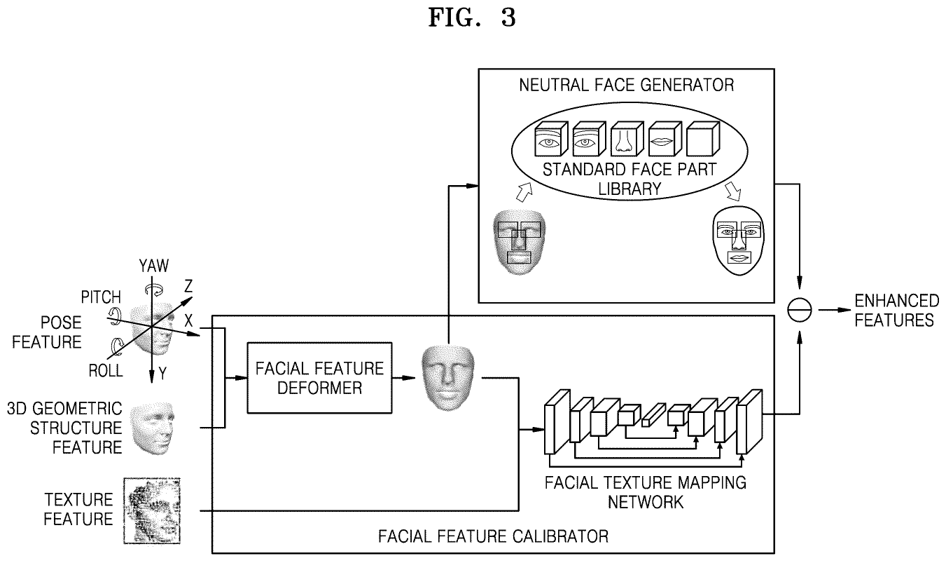

FIG. 3 is a schematic diagram illustrating a method of generating enhanced features according to an exemplary embodiment of the disclosure. According to an embodiment, feature enhancement may be performed by a neutral face generator and a facial feature calibrator of the disclosure. The facial feature calibrator may be formed by a neural network. For example, the facial feature calibrator may include a facial feature deformer and a facial texture mapping network. However, the disclosure is not limited thereto, and as such, the facial feature calibrator may include one or more other components.

Referring to FIG. 3, the facial feature deformer may transform a 3D geometric structure feature in the first face image into a first geometric structure feature corresponding to a forward face direction based on a pose feature in the first face image. For example, the facial feature deformer may receive the 3D geometric structure feature and the pose feature corresponding to the first face image and generate the first geometric structure feature. According to an embodiment, the facial texture mapping network may receive the first geometric structure feature output by the facial feature deformer and a texture feature in the first face image, and obtain a forward face image with the texture feature. For example, the facial feature deformer may transform the 3D geometric feature in the first face image to the forward face direction, and the facial texture mapping network may attach the texture feature in the first face image to the transformed 3D geometry to obtain detailed 3D facial features with the texture feature along the forward face direction.

According to an embodiment, the neutral face generator may receive the first geometric structure feature output by the facial feature deformer and obtain a second face image. For example, the second face image may be generated or obtained as illustrated with reference to FIG. 2. After obtaining the second face image by the neutral face generator, enhanced features of the user may be obtained based on the forward face image and the second face image. Here, the enhanced features may include at least one of the 3D geometric structure feature and the texture feature, or may include the personalized feature in the texture feature. The network structure described in FIG. 3 is only exemplary and the disclosure is not limited thereto.

According to one or more embodiments of the disclosure, the method may include transforming a 3D geometric structure feature in the enhanced features or a 3D geometric structure feature in the first face image into a second geometric structure feature corresponding to a pose in the third face image based on a pose feature in the third face image and the pose feature in the first face image, performing texture mapping based on a texture feature in the enhanced features and the second geometric structure feature to obtain a mapped texture feature, and obtaining the first facial features of the user based on the second geometric structure feature, the mapped texture feature, and the 3D geometric structure feature and the texture feature in the third face image.

For example, the first facial features may be obtained by inputting the second geometric structure feature, the mapped texture feature, and the 3D geometric structure feature and the texture feature in the third face image into a neural network.

As another example, a second query vector of a second attention network may be obtained based on the 3D geometric structure feature and the texture feature in the third face image, a second key vector and a second value vector of the second attention network may be obtained based on the second geometric structure feature and the mapped texture feature, respectively, and the first facial features may be obtained using the second attention network based on the second query vector, the second key vector and the second value vector.

In addition, in order to measure the extent to which the first face image is utilized in restoring the third face image (e.g., how much information in the first face image is required in restoring the third face image), the method may include determining a weight applied to the first facial features may be determined. The method may further include obtaining weighted first facial features based on the weight and the first facial features, and obtaining the personalized facial features of the user based on the weighted first facial features and the second facial features.

As an example, the weight applied to the first facial features may be determined based on at least one of geometric structure consistency information between the third face image and the first face image and weight control information input by a user.

The 3D geometric structure feature in the enhanced features or the 3D geometric structure feature in the first face image may be transformed into the second geometric structure feature corresponding to the pose in the third face image based on the pose feature in the third face image and the pose feature in the first face image, and the geometric structure consistency information may be obtained based on the second geometric structure feature and the 3D geometric structure feature in the third face image.

For example, normalization may be performed on the second geometric structure feature and the 3D geometric structure feature in the third face image, respectively, and the geometric structure consistency information may be obtained using a fully connected network based on the normalized features.

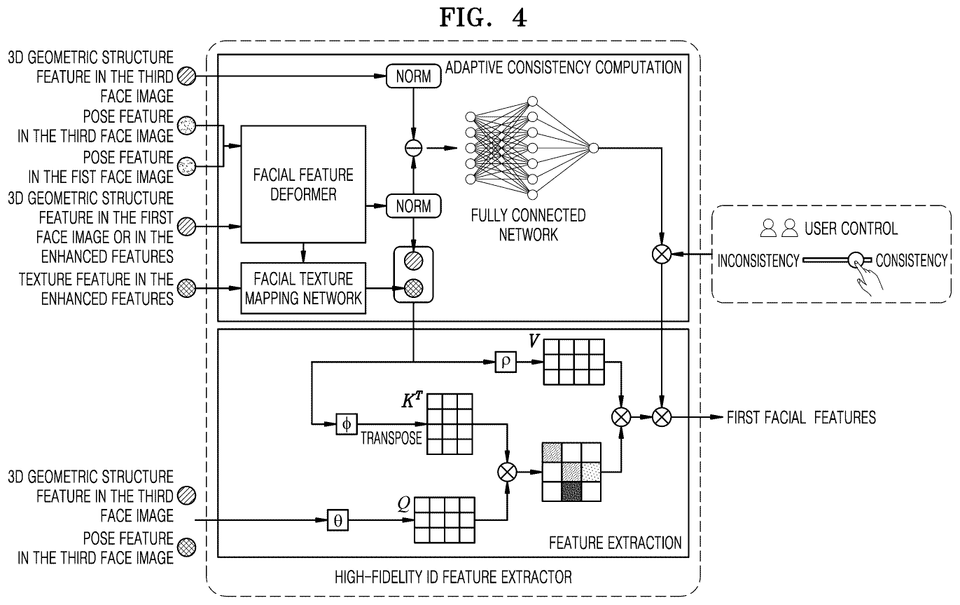

FIG. 4 is a schematic diagram illustrating a method of obtaining first facial features according to an exemplary embodiment of the disclosure. The first facial features may be obtained by a high-fidelity ID feature extractor of the disclosure. The high-fidelity ID feature extractor may be implemented by a neural network.

Referring to FIG. 4, a facial feature deformer in the high-fidelity ID feature extractor may transform a 3D geometric structure feature in the enhanced features or a 3D geometric structure feature in the first face image into a second geometric structure feature corresponding to a pose in the third face image based on a pose feature in the third face image and a pose feature in the first face image. For example, a transformation matrix may be calculated based on the third face image and the first face image, and based on transformation matrix, the 3D geometric structure feature in the first face image is transformed into the second geometric structure feature corresponding to the pose in the third face image, such that the third face image matches the pose in the first face image.

A facial texture mapping network in the high-fidelity ID feature extractor may perform texture mapping based on the texture feature in the enhanced features and the second geometric structure feature to obtain a mapped texture feature.

According to an embodiment, the mapped texture feature and the normalized second geometric structure feature may be used for subsequent feature extraction. In the subsequent feature extraction, the feature extraction may be performed using a second attention network. The normalization operation may ensure that the features are represented in a normalized metric space.

For example, a second query vector of the second attention network may be obtained based on the 3D geometric structure feature and the texture feature in the third face image, a second key vector and a second value vector of the second attention network may be obtained based on the normalized second geometric structure feature (or the second geometric structure feature) and the mapped texture feature, respectively, and the first facial features are obtained based on the second query vector, the second key vector and the second value vector using the second attention network. In FIG. 4, Θ, φ and ρ may represent preprocessing operations on the input features to obtain feature matrixes of the input features. K^{T} represents a transpose of a feature matrix. The first facial features may be obtained by performing a multiplication operation based on the second query vector Q and the second key vector K^{T}, and multiplying the result of the operation with the second value vector V.

The second geometric structure feature and the 3D geometric structure feature in the third face image may be normalized separately, and the geometric structure consistency information may be obtained using a fully connected network based on the normalized features. The geometric structure consistency information may also be referred to as a confidence level for the third face image.

In addition, a weight applied to the first facial features may be determined based on at least one of the geometric structure consistency information between the third face image and the first face image and the weight control information input by a user. For example, a value of the geometric structure consistency information may be multiplied with a weight value input by the user to obtain a final weight. The final weight is applied to the first facial features to obtain the final first facial features. For example, when the third face image is unclear and the user expects to retain fewer attributes in the third face image, the user may input a higher weight value for the first facial features. The network structure shown in FIG. 4 is only exemplary and the disclosure is not limited thereto.

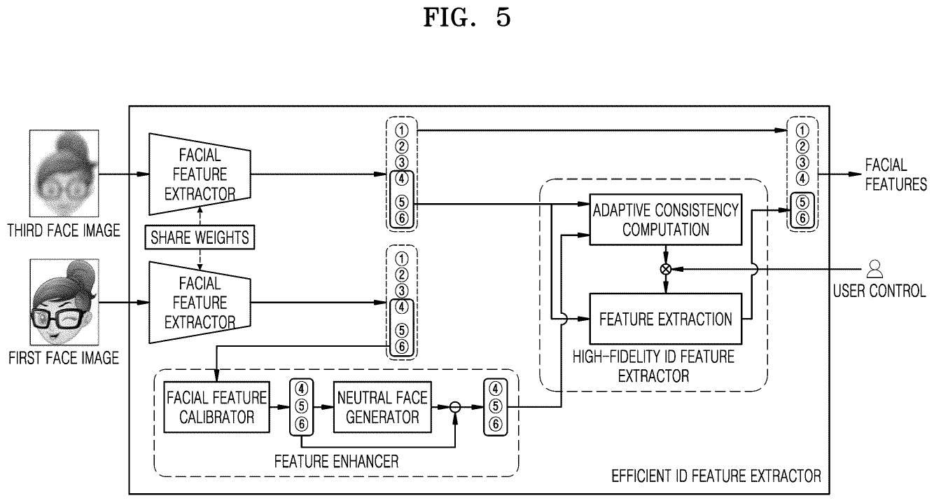

FIG. 5 is a schematic diagram illustrating a method of obtaining personalized facial features of a user based on a third face image and a first face image according to an exemplary embodiment of the disclosure. The extraction of the personalized facial features may be achieved by an efficient ID feature extractor. For example, the efficient ID feature extractor may be achieved by a neural network and may include, but is not limited to, a facial feature extractor, a feature enhancer, and a high-fidelity ID feature extractor.

Referring to FIG. 5, the method may include extracting feature information from the third face image and the first face image. For example, at least one of a brightness feature 1, a color feature 2, an expression feature 3, a pose feature 4, a 3D geometric structure feature 5, and a texture feature 6, etc., of a face may be extracted from the third face image and the first face image, respectively, using the facial feature extractor. The disclosure is not limited to six features, and as such, according to another embodiment, the method may include extracting more than six features or less than six features, The two facial feature extractors in FIG. 5 may be the same or different. In the case where the two facial feature extractors are different, the two facial feature extractors may share weights.

The brightness feature, the color feature, the expression feature and the pose feature extracted from the third face image may be directly used as second facial features of the user.

The feature enhancer may be used to perform feature enhancement on the 3D geometric structural feature and the texture feature in the first face image. The feature enhancer may include a facial feature calibrator and a neutral face generator. For example, the pose feature, the 3D geometric structure feature, and the texture feature in the first face image may be input to the feature enhancer, and the pose feature in the first face image and an enhanced 3D geometric structure feature and an enhanced texture feature may be output. The process of generating the enhanced features may be described with reference to FIG. 3 and will not be repeated here. In FIG. 5, it is illustrated that the feature enhancer may output the pose feature, the 3D geometric structure feature, and the texture feature, but the disclosure is not limited thereto. The feature enhancer may output the 3D geometric structure feature and the texture feature, and the 3D geometric structure feature and the texture feature output by the feature enhancer and the pose feature from the first face image are input to the high-fidelity ID feature extractor.

The high-fidelity ID feature extractor may obtain geometric structure consistency information. For example, the high-fidelity ID feature extractor may perform an adaptive consistency computation based on the pose feature, the 3D geometric structure feature and the texture feature in the third face image and the output of the feature enhancer, and may obtain the first facial features based on the 3D geometric structure feature and the texture feature in the third face image and the normalized second geometric structure feature obtained in the adaptive consistency computation process and the mapped texture feature.

The obtained first facial features may be weighted based on a weight input by the user combined with the geometric structure consistency information. For example, the user may adjust a weight of the first facial features based on a preference of the user. For example, the user may adjust a weight by considering a degree or an amount of different between the first face image and the third image. The method may further include obtaining the personalized facial features of the user based on the weighted first facial features and the second facial features from the third face image.

At operation S103, image restoration is performed on the third face image based on the obtained personalized facial features to obtain a fourth face image corresponding to the third face image.

As an example, the image restoration may be performed using a diffusion model. The diffusion model may include an encoder for feature encoding, a neural network for performing a diffusion process, and a decoder for feature decoding. For example, feature encoding of the third face image may be performed by the encoder of the diffusion model to obtain encoded features of the third face image, and feature reconstruction of the encoded features may be performed based on the obtained personalized facial features of the user using the neural network in the diffusion model, to obtain reconstructed features. The neural network may include, but is not limited to, a Unet. Feature decoding of the reconstructed features is performed by the decoder of the diffusion model to obtain the fourth face image corresponding to the third face image, e.g., a restored face image.

According to one or more embodiments of the disclosure, in order to avoid generating artifacts during the execution of the diffusion process, an artifact image corresponding to the third face image may be obtained. For example, the artifact image may be degraded. For example, the method may include obtaining a degraded artifact image as negative samples of the diffusion model. For example, the method may include performing a diffusion process on the third face image (e.g., the coded features of the third face image) based on the negative samples, the first face image (as positive samples of the diffusion model) and the personalized facial features of the user, using the neural network in the diffusion model to obtain first reconstructed features corresponding to the negative samples and second reconstructed features corresponding to the first face image. The method may further include obtaining reconstructed features of the third face image based on the first reconstructed features and the second reconstructed features, and obtaining the fourth face image corresponding to the third face image based on the reconstructed features.

In generating the artifact image, a region in which an artifact exists in the third face image may be determined based on the third face image and a standard face library, and an artifact generation operation may be performed on the region to obtain the artifact image. The standard face library may be predetermined or pre-established.

For example, face landmarks in the third face image may be aligned with face landmarks in the standard face library. After the alignment, semantic information of a face region in the third face image may be compared with semantic information of a corresponding face region in the standard face library, and a face region with inconsistent semantic information may be determined as a region in which an artifact exists. According to an embodiment, an artifact generation operation may be performed on the region to obtain an artifact image. For example, at least one singular operator corresponding to the region may be selected from a pre-established singular operator library, and the artifact generation operation may be performed on the region using the selected at least one singular operator.

In performing the degradation process, the artifact image may be downsampled to obtain a downsampled artifact image, and the downsampled artifact image may be upsampled to obtain a degraded artifact image.

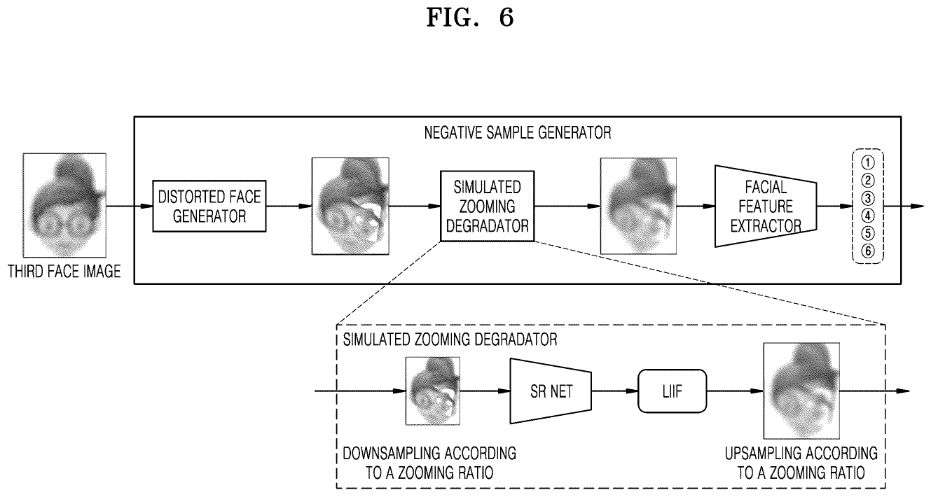

FIG. 6 is a schematic diagram illustrating a method of generating negative samples according to an exemplary embodiment of the disclosure. The negative samples may be generated by a neural network-based negative sample generator. The negative sample generator may detect regions in the third face image where artifacts may appear, generate a semantically related artifact image for the regions where artifacts may appear, degrade the generated artifact image, and use the degraded artifact image as the negative samples of the diffusion model for use in reconstruction of the third face image.

Referring to FIG. 6, the negative sample generator may include a distorted face generator, a simulated zooming degradator and a facial feature extractor, all of which may be formed by a neural network.

The distorted face generator may be used to generate a distorted face image. The distorted face image may also be referred to as a deformed face or a weird image. The face landmarks in the third face image may be aligned with the face landmarks in the standard face library. After alignment, the semantic information of the face regions in the third face image may be compared with the semantic information of the corresponding face regions in the standard face library to find potential semantic regions that may have characteristic artifacts. By performing artifact generation operation on these potential semantic regions, the distorted face image is generated accordingly.

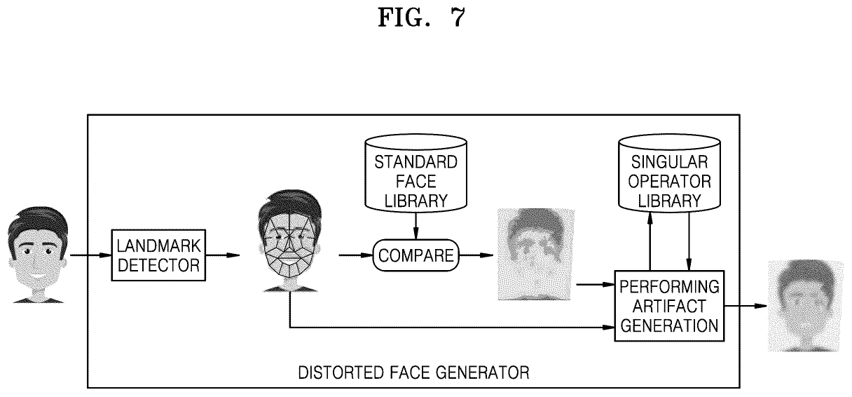

FIG. 7 is a schematic diagram of a distorted face generator according to an exemplary embodiment of the disclosure.

As shown in the distorted face generator of FIG. 7, the distorted face generator may include a landmark detector, a standard face library, and a singular operator library. The landmark detector may, for example, be formed by a neural network.

The landmark detector may be used to capture an overall facial structure of the third face image. The landmark detector may not perform semantic segmentation considering the robustness of the landmarks. The landmark detector may detect regions with incomplete or distorted facial features due to blurring and inaccurate semantic information.

A standard face library may be established in advance using a series of standard faces and stored in the distorted face generator. In the distorted face generator, regions with incomplete or distorted facial features due to blurring and inaccurate semantic information are extracted by comparing the face landmarks of the third face image with the face landmarks in the standard face library.

For potential artifacts that may occur in different facial regions, a singular operator library may be established in advance. For example, for a facial skin region, the region is prone to generate a non-skin texture feature such as hair on the face. In this case, a localized random reproduction operator may be applied to this region. As another example, for a region that primarily includes a face part, the region is prone to characteristic artifacts such as localized deformations. The localized deformations may include, but is not limited to a distorted corner of the eye or mouth. In this case, a local distortion operator may be applied to this region. In addition, the singular operator library may further include a global operator for overall face distortion, a local shift operator for boundary occlusion (e.g., a hat occluding the face), a local random replica slice operator for hair on the face, a local missing operator for a missing wearable object (e.g., eyeglasses) on the face, and the like. The above examples are only exemplary and the disclosure is not limited thereto.

An artifact generation operation may be performed to obtain a distorted face image by randomly selecting at least one operator from the singular operator library to apply to the region according to detected regions in which characteristic artifacts may appear.

Returning to FIG. 6, the simulated zooming degrader may simulate various forms of degeneration depending on situations. For example, the simulated zooming degrader may dynamically downsample a generated deformed face image based on a zooming ratio (zooming magnification) of the image, and upsample the downsampled image by means of a super-resolution reconstruction (SR) network and a local implicit image function (LIIF) to simulate a zooming operation.

The facial feature extractor extracts features from the degraded artifact image. The extracted features (negative features) may be used for inverse supervision of feature reconstruction to avoid potential characteristic artifacts.

As shown in FIG. 6, the features extracted from the degraded artifact image may be used as the negative samples. Optionally, the degraded artifact image may be used as the negative samples, in which case the negative sample generator may not include the facial feature extractor. The structure shown in FIG. 6 is only exemplary and the disclosure is not limited thereto.

According to one or more embodiments of the disclosure, considering that there may be differences between the texture feature reconstructed by the diffusion model and the actual texture feature, the disclosure may dynamically adjust convolution kernels of adaptive convolution by using the extracted personalized facial features, such that different convolution kernels may be applied for different facial regions. That is, the adjusted convolution kernels may have different feature correction capabilities.

As an example, reconstructed features of the third face image may be obtained and decoded features may be obtained by decoding the reconstructed features. For example, the features of the third face image may be reconstructed using the neural network for performing a diffusion process in the diffusion model to obtain the reconstructed features, and the reconstructed features may be decoded by the decoder of the diffusion model to obtain the decoded features.

According to an embodiment, an adaptive convolution kernel corresponding to each pixel region may be generated based on texture features in different pixel regions of the personalized facial features of the user, the decoded features may be texture corrected using the generated adaptive convolution kernels, texture corrected decoded features may be obtained, and the fourth face image corresponding to the third face image may be obtained based on the texture corrected decoded features.

In the diffusion model, the diffusion process takes place in the deep potential space and is mainly configured to generate macroscopic semantics, such as indicate the positions of eyes and mouth. The decoding process is mainly configured to generate fine textures, such as hair. If the decoding process is not properly guided, the generated fine textures may not be consistent with the real textures. Therefore, to ensure the consistency and semantic integrity of the texture corrected decoded features, the disclosure may modulate the corrected decoded features by extracting global information of the reconstructed features reconstructed by the diffusion model.

As an example, global facial features of the user may be obtained based on the reconstructed features of the diffusion model, the texture corrected decoded features are modulated based on the global facial features to obtain the modulated decoded features, and the fourth face image is generated based on the modulated decoded features. For example, the global facial features may include first global facial features and second global facial features. In applying the global facial features, the texture corrected decoded features may be multiplied with the first global facial features to obtain first features, and the first features may be added with the second global facial features to obtain the modulated decoded features.

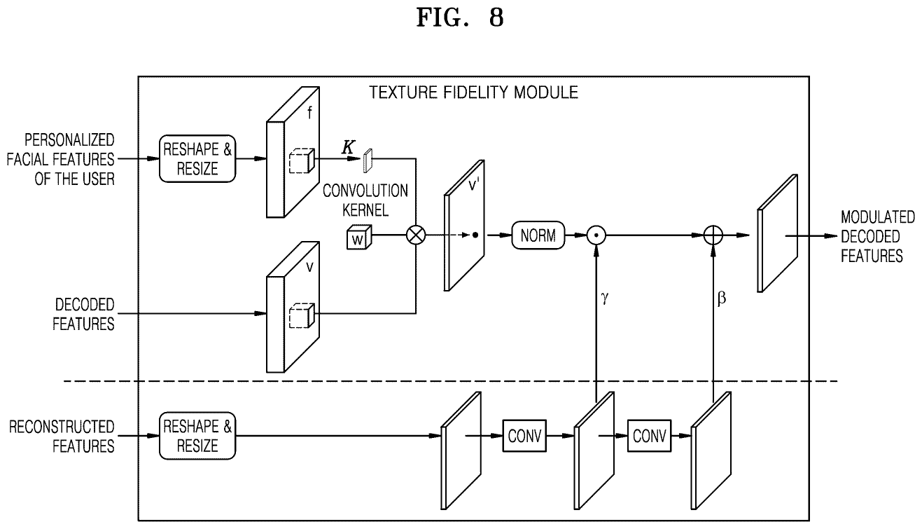

FIG. 8 is a schematic diagram illustrating a method of modulating decoded features according to an exemplary embodiment of the disclosure. A modulation operation may be performed by a texture fidelity module of the disclosure. The texture fidelity module may be implemented by a neural network and may include a texture corrector and a semantic consistency and feature integrity module. The upper portion of FIG. 8 (above the dashed line) may represent an operation of the texture corrector and the lower portion of FIG. 8 (below the dashed line) may represent an operation of the semantic consistency and feature integrity module.

According to an embodiment, correction kernels (e.g., convolution kernels) may be generated for different pixel regions by the texture feature in the extracted facial features so that they are applied on a learnable convolution to generate a set of adaptive convolutions for the different pixel regions. This adaptive convolution adapts to the feature patterns of the different pixel regions. For example, the texture of a wrinkled region is different from the texture of a smooth region, and the corresponding adaptive convolution kernels thereof are different. As shown in FIG. 8, the reconstructed features may be firstly reshaped and resized to obtain reshaped and resized features f. Using each pixel region (e.g., a pixel region K) in the features f, a corresponding convolution kernel (e.g., w) is generated, and the corresponding convolution kernel is applied to the same pixel region in the decoded features V, so that the texture corrected feature of the pixel region may be obtained.

The generated adaptive convolution kernels may be applied to different regions of the reconstructed features output by the decoder to realize texture correction for different regions. For example, the texture corrected decoded features V′ is obtained by applying a corresponding convolution kernel to each pixel region.

A first global feature vector (e.g., the first global facial features) γ and a second global feature vector (the second global facial features) β may be extracted from the reconstructed features, respectively. As shown in FIG. 8, the reconstructed features may be firstly reshaped and resized to obtain the reshaped and resized features, and the reshaped and resized features may be subjected to a convolution operation (Conv) to obtain the first global feature vector γ and the second global feature vector β.

The first global feature vector γ may be applied to the corrected decoded features (or the features obtained after normalization (Norm) of the corrected decoded features) in the form of product to obtain the first features, and the second global feature vector β may be applied to the first features in the form of addition. The global feature modulation ensures the integrity and semantic consistency of the output features and further avoids artifacts. The example shown in FIG. 8 is exemplary only and the disclosure is not limited thereto.

According to one or more embodiments of the disclosure, based on the diffusion model, the disclosure addresses the problem of insufficient fidelity by utilizing a high-quality reference face image and introducing two components, e.g., an efficient ID feature extractor and a texture fidelity module. The two components may be specialized to ensure fidelity on the identity and on the texture, respectively. Furthermore, an adaptive negative sample generator is introduced to guide the diffusion process to avoid generating artifacts.

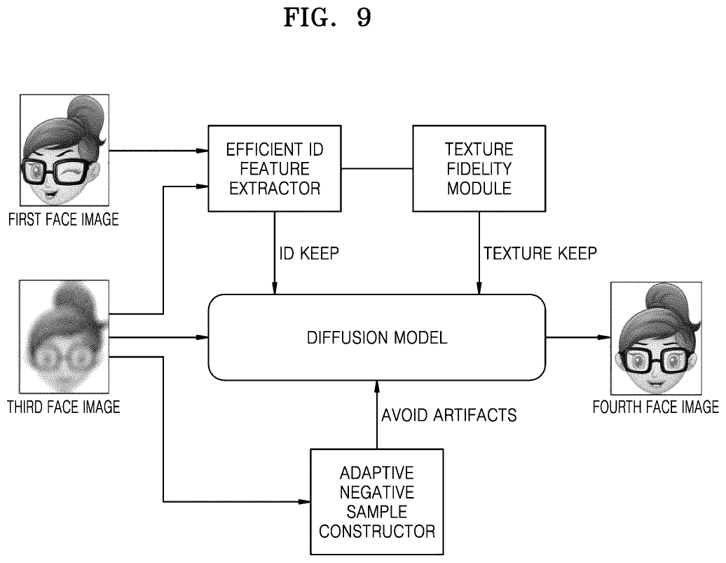

FIG. 9 is a diagram of an overall architecture for face image restoration according to an exemplary embodiment of the disclosure.

Referring to FIG. 9, highly distinguishable ID features (such as the first facial features) may be extracted by the efficient ID feature extractor. For example, the high efficiency ID feature extractor may perform the operations described above with reference to FIG. 5. The features extracted by the high-efficiency ID feature extractor may be applied to a diffusion process in the potential space, and the extracted texture feature may be used to dynamically correct intermediate diffusion results. For example, the texture fidelity module may perform the operations described above with reference to FIG. 8. In addition, the constructed negative samples may also influence the diffusion process in the potential space and guide the diffusion model to avoid generating artifacts. For example, the negative sample generator may perform the operations described above with reference to FIG. 6 and apply the generated negative samples to the diffusion process of the diffusion model.

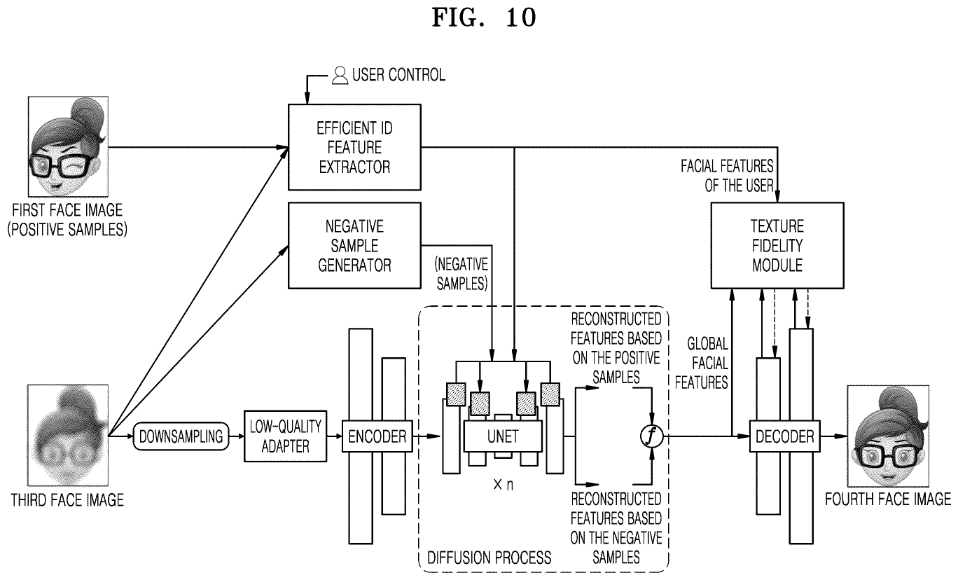

FIG. 10 is a schematic diagram illustrating a method of face image restoration according to an exemplary embodiment of the disclosure.

Referring to FIG. 10, personalized facial features of a user may be obtained based on a third face image and a first face image using the efficient ID feature extractor of the disclosure. The efficient ID feature extractor may perform the operations as described above with reference to FIG. 5.

Negative samples for the diffusion model may be obtained based on the third face image using the negative sample generator of the disclosure, which may perform the operations as described above with reference to FIG. 6. In addition, a first face image may be used as positive samples for the diffusion model.

When running the diffusion model, the third face image may first be downsampled, and encoded features of the third face image may be obtained by means of a low-quality adapter as well as an encoder. A diffusion process may be performed using a neural network in the diffusion model based on the encoded features, the negative samples, and the personalized facial features from the efficient ID feature extractor to obtain reconstructed features based on the positive samples and reconstructed features based on the negative samples, and a decimation function (f) may be applied on the reconstructed features based on the positive samples and the reconstructed features based on the negative samples to obtain reconstructed features of the third face image. The neural network may include, but is not limited to, a Unet.

The texture fidelity module may extract global facial features from the reconstructed features of the third face image, and based on the facial features output from the efficient ID feature extractor and the global facial features, the texture fidelity module may feature correct or modulate decoded features obtained by decoding the reconstructed features via the decoder of the diffusion model to obtain modulated decoded features. The texture fidelity module may further generate the fourth face image corresponding to the third face image based on the modulated decoded features.

According to one or more embodiments of the disclosure, more detailed features for face restoration are obtained by referring to a high-quality face image of the same user, and the fidelity of the user identity of the restored image is ensured by extracting efficient ID features and applying them to the feature reconstruction of the diffusion model. The fidelity of the texture of the restored image may be ensured by texture correction of the reconstructed features of the diffusion model using the extracted texture feature, and the integrity and semantic consistency of the output features are ensured by modulating the texture corrected features using the global information extracted from the reconstructed features, which further avoids generation of artifacts. The diffusion process is guided to avoid generation of artifacts by introducing constructed negative samples in the diffusion process of the diffusion model.

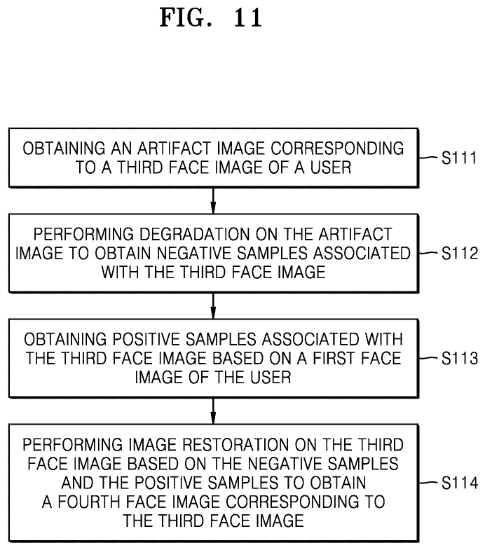

FIG. 11 is a flowchart of a method performed by an electronic apparatus according to another exemplary embodiment of the disclosure.

Referring to FIG. 11, at operation S111, an artifact image corresponding to a third face image of a user is obtained. The third face image may be a face image to be restored.

As an example, a region in which an artifact exists in the third face image may be determined based on the third face image and a pre-established standard face library, and an artifact generation operation may be performed on the region to obtain the artifact image.

For example, face landmarks in the third face image may be aligned with face landmarks in the standard face library. Then, semantic information of the face region in the third face image is compared with semantic information of the corresponding face region in the standard face library. Face regions with inconsistent semantic information are identified as regions with artifacts.

In performing the artifact generation operation on the region in which the artifact exists, at least one singular operator corresponding to the region may be selected from a pre-established singular operator library, and the artifact generation operation may be performed on the region using the selected at least one singular operator. For example, the artifact image may be obtained according to the operation described above with reference to FIG. 7.

At operation S112, the artifact image is degraded to obtain negative samples associated with the third face image.

As an example, the artifact image may be downsampled to obtain a downsampled artifact image, and the downsampled artifact image may be upsampled to obtain a degraded artifact image. The degraded artifact image may be used as negative samples. For example, the negative samples may be obtained in accordance with the operation described above with reference to FIG. 6.

At operation S113, based on a first face image of the user, positive samples associated with the third face image is obtained. The first face image may be a clear, high-quality face image belonging to the same user as the third face image. For example, the first face image may be used as positive samples.

At operation S114, image restoration is performed on the third face image based on the negative samples and the positive samples to obtain a fourth face image corresponding to the third face image.

As an example, a diffusion process may be performed on the third face image using a diffusion model based on the negative samples and the positive samples to obtain first reconstructed features corresponding to the negative samples and second reconstructed features corresponding to the positive samples, reconstructed features of the third face image may be obtained based on the first reconstructed features and the second reconstructed features, and the fourth face image corresponding to the third face image may be obtained based on the reconstructed features.

For example, referring to FIG. 10, the first reconstructed features and the second reconstructed features may be obtained by performing the diffusion process through the neural network of the diffusion model based on the positive samples and the negative samples, the reconstructed features of the third face image are obtained by processing (such as cascading) the first reconstructed features and the second reconstructed features, and the fourth face image corresponding to the third face image is obtained by the decoder of the diffusion model based on the reconstructed features.

According to one or more embodiments of the disclosure, by performing image restoration based on the negative samples used for image restoration, artifacts are avoided to be generated during the image restoration process, thereby obtaining a clearer face image.

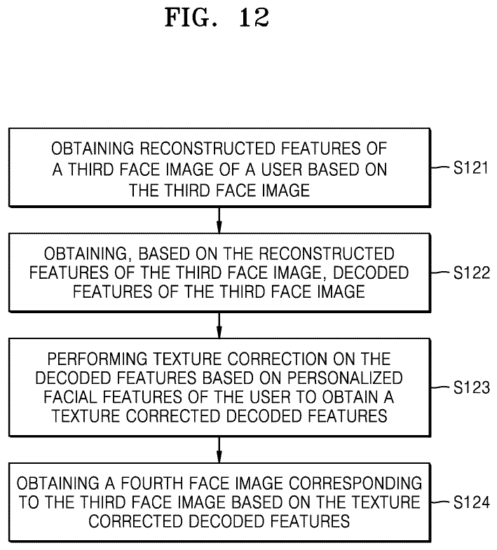

FIG. 12 is a flowchart of a method performed by an electronic apparatus according to yet another exemplary embodiment of the disclosure.

Referring to FIG. 12, at operation S121, reconstructed features of a third face image of a user are obtained based on the third face image. The third face image may be a face image to be restored.

At operation S122, based on the reconstructed features of the third face image, decoded features of the third face image are obtained.

For example, referring to FIG. 10, the neural network of the diffusion model may be used to perform the diffusion process on the third face image to obtain the reconstructed features of the third face image, and the decoder of the diffusion model may be used to decode the reconstructed features to obtain the decoded features.

At operation S123, the decoded features are texture corrected based on personalized facial features of the user, to obtain texture corrected decoded features.

The personalized facial features may be obtained by obtaining a second face image based on a first face image of the user, and obtaining the personalized facial features based on the first face image, the second face image, and the third face image. Here, the second face image represents a face image that does not include the personalized facial features.

The second face image may be generated for individual face regions in the first face image based on a pre-established face part library.

As an example, an adaptive convolution kernel corresponding to each pixel region is generated based on texture features in different pixel regions of the personalized facial features, and texture correction is performed on the decoded features using the generated adaptive convolution kernels to obtain the texture corrected decoded features. For example, the texture corrected decoded features may be obtained in accordance with the operations described above with reference to FIG. 8.

At operation S124, a fourth face image corresponding to the third face image is obtained based on the texture corrected decoded features.

As an example, global facial features of the user may be obtained based on the reconstructed features of the third face image, the modulated decoded features may be obtained by modulating the texture corrected decoded features based on the global facial features, and; and the fourth face image may be generated based on the modulated decoded features.

Optionally, the global facial features may include first global facial features and second global facial features. In this case, the texture corrected decoded features may be multiplied with the first global facial features to obtain the first features, and the first features may be added with the second global facial features to obtain the modulated decoded features. The modulated decoded features are used to generate the fourth image. For example, the modulated decoded features may be obtained according to the operation described above with reference to FIG. 8.

According to one or more embodiments of the disclosure, texture fidelity of the restored face image is ensured by texture correction of the decoded features of the face image to be restored based on the personalized facial features of the user.

The methods of the disclosure may be applied, for example, to scenarios in which zooming shots are taken and to scenarios in which images in a photo album are edited.

For example, when a user is far away from a target object and a zooming mode is used to capture the target object, a face in the captured image may not be clear. In this case, the electronic apparatus may recommend to the user a number of clear face images that are closest to an identity of the target object based on the captured image. The user may select a face image consistent with the identity of the target object, as a reference face image, from the recommended clear face images. The user may adjust the selected reference face image (such as adjusting a reference ratio of the reference face image) or use default setting values. The captured image may be subjected to face restoration using a method of the disclosure (e.g., the method described with reference to FIG. 10) to obtain a clear image of the target object.

As another example, a user may select a face image expected to be restored from an album of the electronic apparatus, such as selecting a low-quality face image that includes a plurality of faces. In this case, the electronic apparatus may first automatically detect all faces in the selected image, from which the user may select a target face expected to be restored. According to an embodiment, the electronic apparatus may, based on the target face, recommend to the user a number of clear face images that are closest to an identity of that target face. The user may select a face image consistent with the identity of the target face, as a reference face image, from the recommended clear face images. The user may adjust the selected reference face image (such as adjusting a reference ratio of the reference face image) or use default setting values. The face image expected to be restored may be restored using a method of the disclosure (e.g., the method described with reference to FIG. 10) to obtain an image in which the image quality of the target face is improved. After restoring the target face in the face image expected to be restored, the current operation may be ended when the restored image meets the requirements of a user. When the user expects to continue restoring other faces in the image, another target face may be selected from among the previously detected other faces for image restoration in accordance with the above operation.

The above exemplary scenarios are only exemplary, and the disclosure is not limited thereto.

In the foregoing, the methods performed by the electronic apparatus according to exemplary embodiments of the disclosure have been described.

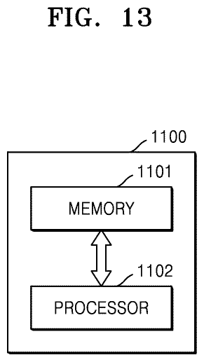

FIG. 13 is a block diagram illustrating an electronic apparatus according to exemplary embodiments of the disclosure. Referring to FIG. 13, the electronic apparatus 1100 may include a memory 1101 and a processor 1102. The processor 1102 may be coupled to the memory 1101 and configured to perform any method described above. For example, the memory 1101 may store computer programs, software code or executable instructions for performing methods and/or operations of one or more embodiments of the disclosure. The memory 1101 may be controlled by the processor 1102 for execution of computer programs, software code or executable instructions and/or for storing data. The processor 1102 may execute the computer programs or executable instructions stored in the memory 1101 to implement the operations and/or methods of one or more embodiments of the disclosure.

However, the disclosure is not limited thereto, and as such, according to another embodiment, there is provided an electronic apparatus that further includes at least one transceiver and/or other components.

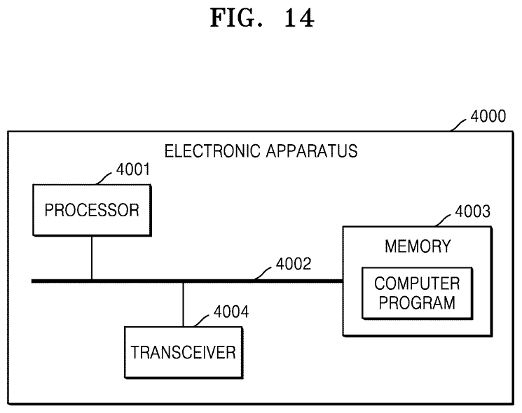

FIG. 14 illustrates a schematic diagram of a structure of an electronic apparatus applicable to exemplary embodiments of the disclosure. As shown in FIG. 14, the electronic apparatus 4000 may include a processor 4001 and a memory 4003. The processor 4001 and the memory 4003 may be coupled, for example, through a bus 4002. According to an embodiment, the electronic apparatus 4000 may further include a transceiver 4004 which may be used for data interaction between the electronic apparatus and other electronic apparatuses, such as transmitting of data and/or receiving of data. It should be noted that, each of the processor 4001, the memory 4003, and the transceiver 4004 is not limited to one in a practice application, and the structure of the electronic apparatus 4000 does not constitute a limitation of the embodiments of the disclosure. As such, according to an embodiment, the electronic apparatus may include one or more memories, one or more processors, one or more transceivers, or one or more other components.

According to an embodiment, the electronic apparatus may be the first network node, the second network node, or the third network node.

The processor 4001 may be a Central Processing Unit (CPU), general purpose processor, Digital Signal Processor (DSP), Application Specific Integrated Circuit (ASIC), Field Programmable Gate Array (FPGA) or other programmable logic device, transistor logic device, hardware part, or any combination thereof. It may implement or perform various exemplary logic boxes, modules, and circuits described in conjunction with the disclosed contents of the disclosure. The processor 4001 may also be a combination that implements computing functions, such as a combination containing one or more microprocessors, a combination of a DSP and a microprocessor, and the like.

The bus 4002 may include a pathway to transfer information between the above components. The bus 4002 may be a Peripheral Component Interconnect (PCI) bus or an Extended Industry Standard Architecture (EISA) bus, and the like. The bus 4002 may be classed as an address bus, a data bus, a control bus, and the like. For ease of representation, only one bold line is shown in FIG. 14, but it does not mean that there is only one bus or one type of bus.

The memory 4003 may be a Read Only Memory (ROM) or other types of static storage apparatuses that can store static information and instructions, a Random Access Memory (RAM) or other types of dynamic storage apparatuses that can store information and instructions, may be an Electrically Erasable Programmable Read Only Memory (EEPROM), Compact Disc Read Only Memory (CD-ROM) or other optical disc storages, an optical disc storage (including a compressed disc, laser disc, optical disc, digital universal disc, Blu-ray disc, etc.), a disk storage medium, other magnetic storage apparatuses, or any other medium that can be used to carry or store computer programs and can be read by a computer, it is not limited herein.

The memory 4003 may store computer programs, software code or executable instructions for performing methods and/or operations of one or more embodiments of the disclosure. The memory 4003 may be controlled by a processor 4001 for execution of computer programs, software code or executable instructions and/or for storing data. The processor 4001 may execute the computer programs or executable instructions stored in the memory 4003 to implement the operations and/or methods of one or more embodiments of the disclosure.

An embodiment of the disclosure provides a computer readable storage medium storing computer programs or instructions, the computer programs or instructions, when being executed by at least one processor may perform or implement the operations in the preceding method of the embodiments and corresponding contents.

An embodiment of the disclosure provides a computer program product including computer programs, the computer programs, when being executed by a processor, may implement the operations shown in the method of the one or more embodiments of the disclosure and corresponding contents.

The terms “first”, “second”, “third”, “fourth”, “1”, “2” and the like in the specification and claims of the disclosure and the above drawings are used to distinguish similar objects, and need not be used to describe a specific order or sequence. It should be understood that, data used as such may be interchanged in appropriate situations, so that the embodiments of the disclosure described here may be implemented in an order other than the illustration or text description.

It should be understood that, although each operation is indicated by an arrow in the flowcharts of the embodiments of the disclosure, an implementation order of these operations is not limited to an order indicated by the arrows. Unless explicitly stated herein, in some implementation scenarios of the embodiments of the disclosure, the implementation operations in the flowcharts may be executed in other orders according to requirements. In addition, some or all of the operations in each flowchart may include a plurality of sub-steps, sub-operations or stages, based on an actual implementation scenario. Some or all of these sub-steps, sub-operations or stages may be executed at the same time, and each sub-steps, sub-operations or stage in these sub-steps, sub-operations or stages may also be executed at different times. In scenarios with different execution times, an execution order of these sub-steps, sub-operations or stages may be flexibly configured according to a requirement, which is not limited by the embodiment of the disclosure.

The above text and accompanying drawings are provided as examples only to assist readers in understanding the disclosure. They are not intended and should not be interpreted as limiting the scope of the disclosure in any way. Although certain embodiments and examples have been provided, based on the content disclosed herein, it is apparent to those skilled in the art that, changes can be made to the illustrated embodiments and examples without departing from the scope of the disclosure, and other similar implementation methods based on the technical concepts of the disclosure also belongs to a protection scope of the embodiments of the disclosure.

According to an aspect of the disclosure, there is provided a method performed by an electronic apparatus, including: obtaining a first face image of a subject, which is a high-quality reference face image of the subject with image quality higher than a threshold value; obtaining a second face image of the subject based on the first face image of the subject, the second face image comprising neutral facial features for each part of a face of the subject; when obtaining a third face image, which is a degraded face image of the subject with image quality lower than the threshold value, obtaining one or more personalized facial features of the subject based on the first face image, the second face image and a third face image of the subject; performing image restoration on the third face image based on the one or more personalized facial features to obtain a fourth face image corresponding to the third face image; and outputting the fourth face image corresponding to the third face image.

The second face image may be generated for one or more face regions in the first face image based on a pre-established face part library.

The obtaining the one or more personalized facial features of the subject based on the first face image, the second face image and the third face image of the subject may include obtaining one or more first facial features of the subject, based on the first face image, the second face image and the third face image; obtaining one or more second facial features extracted from the third face image; and obtaining the one or more personalized facial features of the subject based on the one or more first facial features and one or more second facial features.

The one or more first facial features may include at least one of a three-dimensional geometric structure feature and a texture feature of the face; and the one or more second facial features comprise at least one of a brightness feature, a color feature, an expression feature, and a pose feature of the face.

The obtaining the second face image of the subject based on the first face image of the subject may include transforming the first face image into a first geometric structure feature corresponding to a set direction; determining a plurality of face part features based on a pre-established face part library, each of the plurality of face part features corresponding to one of a plurality of parts of the face corresponding to the first geometric structure feature; and obtaining the second face image based on the plurality of face part features.

The determining the plurality of face part features may include determining, for the each of the plurality of parts of the face, n clustering centers from the face part library, wherein n is a positive integer greater than or equal to 1; and obtaining the plurality of face part features based on the n clustering centers using a first attention network.

The obtaining the plurality of face part features may include for each of the plurality of parts: using a feature of a respective part in the first geometric structure feature as a first query vector of the first attention network; extracting a first key vector and a first value vector of the first attention network from each of the n clustering centers of the respective part; obtaining n intermediate features using the first attention network based on the first query vector, the first key vector, and the first value vector corresponding to each of the n clustering centers; and obtaining the feature of the respective part in the face by performing feature fusion on the n intermediate features.

The obtaining the one or more first facial features may include transforming the first face image into a first geometric structure feature corresponding to a set direction; based on the first geometric structure feature and a texture feature in the first face image, obtaining a face image having the texture feature; obtaining enhanced features of the subject based on the face image having the texture feature and the second face image; and obtaining the one or more first facial features based on the enhanced features, and a texture feature and a three-dimensional geometric structure feature in the third face image.

The set direction may be a forward face direction.

The obtaining the one or more first facial features may include transforming a three-dimensional geometric structure feature in the enhanced features or a three-dimensional geometric structure feature in the first face image into a second geometric structure feature corresponding to a pose in the third face image based on a pose feature in the third face image and a pose feature in the first face image; performing texture mapping based on a texture feature in the enhanced features and the second geometric structure feature to obtain a mapped texture feature; and obtaining the one or more first facial features based on the second geometric structure feature, the mapped texture feature, and the three-dimensional geometric structure feature and the texture feature in the third face image.

The obtaining the one or more first facial features may include obtaining a second query vector of a second attention network based on the three-dimensional geometric structure feature and the texture feature in the third face image; obtaining a second key vector and a second value vector of the second attention network, respectively, based on the second geometric structure feature and the mapped texture feature; and obtaining the one or more first facial features using the second attention network based on the second query vector, the second key vector and the second value vector.

The obtaining the one or more first facial features may include determining a weight to be applied to the one or more first facial features; obtaining weighted one or more first facial features based on the weight and the one or more first facial features; and obtaining the one or more personalized facial features of the subject based on the weighted one or more first facial features and the one or more second facial features.

The determining the weight applied to the one or more first facial features may include determining the weight based on at least one of geometric structure consistency information between the third face image and the first face image and weight control information input by a user.

The determining the weight based on the at least one of the geometric structure consistency information between the third face image and the first face image and the weight control information input by the user may include transforming a three-dimensional geometric structure feature in the enhanced features or a three-dimensional geometric structure feature in the first face image into a second geometric structure feature corresponding to a pose in the third face image based on a pose feature in the third face image and a pose feature in the first face image; and obtaining the geometric structure consistency information based on the second geometric structure feature and a three-dimensional geometric structure feature in the third face image.

The obtaining the geometric structure consistency information based on the second geometric structure feature and the three-dimensional geometric structure feature in the third face image may include performing normalization on the second geometric structure feature and the three-dimensional geometric structure feature in the third face image, respectively; and obtaining the geometric structure consistency information using a fully connected network based on normalized features.

The performing the image restoration on the third face image may include obtaining an artifact image corresponding to the third face image; performing degradation on the artifact image to obtain a degraded artifact image as negative samples of a diffusion model used for the image restoration; performing a diffusion process on the third face image using the diffusion model based on the negative samples, the first face image and the one or more first facial features to obtain first reconstructed features corresponding to the negative samples and second reconstructed features corresponding to the first face image; obtaining reconstructed features of the third face image based on the first reconstructed features and the second reconstructed features; and obtaining the fourth face image corresponding to the third face image based on the reconstructed features.

According to an aspect of the disclosure, there is provided a method performed by an electronic apparatus, including: obtaining an artifact image corresponding to a first face image of a subject; performing degradation on the artifact image to obtain negative samples associated with the first face image; obtaining positive samples associated with the first face image based on a second face image of the subject; and performing image restoration on the first face image based on the negative samples and the positive samples to obtain a third face image corresponding to the first face image.

According to an aspect of the disclosure, there is provided a method performed by an electronic apparatus including: obtaining reconstructed features of a first face image of a subject based on the first face image; obtaining, based on the reconstructed features, decoded features of the first face image; performing texture correction on the decoded features based on one or more first facial features of the subject to obtain a texture corrected decoded features; and obtaining a second face image corresponding to the second face image based on the texture corrected decoded features.

According to an aspect of the disclosure, there is provided an electronic apparatus including: at least one processor; at least one memory storing computer executable instructions; wherein the computer executable instructions, when run by the at least one processor, cause the at least one processor to obtain a first face image of a subject, which is a high-quality reference face image of the subject with image quality higher than a threshold value, obtain a second face image of the subject based on the first face image of the subject, the second face image comprising neutral facial features for each part of a face of the subject, when obtaining a third face image, which is a degraded face image of the subject with image quality lower than the threshold value, obtain one or more personalized facial features of the subject based on the first face image, the second face image and a third face image of the subject, perform image restoration on the third face image based on the one or more personalized facial features to obtain a fourth face image corresponding to the third face image, and output the fourth face image corresponding to the third face image.

According to one or more embodiments of the disclosure, the personalized facial features for face restoration are obtained by referring to a high-quality face image of the same user, and image restoration is performed using the personalized facial features to obtain a face image have better quality (e.g., a clearer face image).

According to one or more embodiments of the disclosure, by performing image restoration based on the negative samples used for image restoration, artifacts are avoided to be generated during the image restoration process, thereby obtaining a face image have better quality (e.g., a clearer face image).

According to one or more embodiments of the disclosure, texture fidelity of the restored face image is ensured by texture correction of the decoded features of the face image to be restored based on the personalized facial features of the user.

What is claimed is:

1. A method performed by an electronic apparatus, comprising:
obtaining a first face image of a subject, which is a high-quality reference face image of the subject with image quality higher than a threshold value;
obtaining a second face image of the subject based on the first face image of the subject, the second face image comprising neutral facial features for each part of a face of the subject;
when obtaining a third face image, which is a degraded face image of the subject with image quality lower than the threshold value, obtaining one or more personalized facial features of the subject based on the first face image, the second face image and a third face image of the subject;
performing image restoration on the third face image based on the one or more personalized facial features to obtain a fourth face image corresponding to the third face image; and
outputting the fourth face image corresponding to the third face image.

2. The method according to claim 1, wherein the second face image is generated for one or more face regions in the first face image based on a pre-established face part library.

3. The method according to claim 1, wherein the obtaining the one or more personalized facial features of the subject based on the first face image, the second face image and the third face image of the subject comprises:
obtaining one or more first facial features of the subject, based on the first face image, the second face image and the third face image;
obtaining one or more second facial features extracted from the third face image; and
obtaining the one or more personalized facial features of the subject based on the one or more first facial features and one or more second facial features.

4. The method according to claim 3, wherein,
the one or more first facial features comprise at least one of a three-dimensional geometric structure feature and a texture feature of the face; and
the one or more second facial features comprise at least one of a brightness feature, a color feature, an expression feature, and a pose feature of the face.

5. The method according to claim 1, wherein the obtaining the second face image of the subject based on the first face image of the subject comprises:
transforming the first face image into a first geometric structure feature corresponding to a set direction;
determining a plurality of face part features based on a pre-established face part library, each of the plurality of face part features corresponding to one of a plurality of parts of the face corresponding to the first geometric structure feature; and
obtaining the second face image based on the plurality of face part features.

6. The method according to claim 5, wherein the determining the plurality of face part features comprises:
determining, for the each of the plurality of parts of the face, n clustering centers from the face part library, wherein n is a positive integer greater than or equal to 1; and
obtaining the plurality of face part features based on the n clustering centers using a first attention network.

7. The method according to claim 6, wherein the obtaining the plurality of face part features comprises:
for each of the plurality of parts:
using a feature of a respective part in the first geometric structure feature as a first query vector of the first attention network;
extracting a first key vector and a first value vector of the first attention network from each of the n clustering centers of the respective part;
obtaining n intermediate features using the first attention network based on the first query vector, the first key vector, and the first value vector corresponding to each of the n clustering centers; and
obtaining the feature of the respective part in the face by performing feature fusion on the n intermediate features.

8. The method according to claim 3, wherein the obtaining the one or more first facial features comprises:
transforming the first face image into a first geometric structure feature corresponding to a set direction;
based on the first geometric structure feature and a texture feature in the first face image, obtaining a face image having the texture feature;
obtaining enhanced features of the subject based on the face image having the texture feature and the second face image; and
obtaining the one or more first facial features based on the enhanced features, and a texture feature and a three-dimensional geometric structure feature in the third face image.

9. The method according to claim 5, wherein the set direction is a forward face direction.

10. The method according to claim 8, wherein the obtaining the one or more first facial features comprises:
transforming a three-dimensional geometric structure feature in the enhanced features or a three-dimensional geometric structure feature in the first face image into a second geometric structure feature corresponding to a pose in the third face image based on a pose feature in the third face image and a pose feature in the first face image;
performing texture mapping based on a texture feature in the enhanced features and the second geometric structure feature to obtain a mapped texture feature; and
obtaining the one or more first facial features based on the second geometric structure feature, the mapped texture feature, and the three-dimensional geometric structure feature and the texture feature in the third face image.

11. The method according to claim 10, wherein the obtaining the one or more first facial features comprises:
obtaining a second query vector of a second attention network based on the three-dimensional geometric structure feature and the texture feature in the third face image;
obtaining a second key vector and a second value vector of the second attention network, respectively, based on the second geometric structure feature and the mapped texture feature; and
obtaining the one or more first facial features using the second attention network based on the second query vector, the second key vector and the second value vector.

12. The method according to claim 8, wherein the obtaining the one or more first facial features comprises:
determining a weight to be applied to the one or more first facial features;
obtaining weighted one or more first facial features based on the weight and the one or more first facial features; and
obtaining the one or more personalized facial features of the subject based on the weighted one or more first facial features and the one or more second facial features.

13. The method according to claim 12, wherein the determining the weight applied to the one or more first facial features comprises:
determining the weight based on at least one of geometric structure consistency information between the third face image and the first face image and weight control information input by a user.

14. The method according to claim 13, wherein the determining the weight based on the at least one of the geometric structure consistency information between the third face image and the first face image and the weight control information input by the user comprises:
transforming a three-dimensional geometric structure feature in the enhanced features or a three-dimensional geometric structure feature in the first face image into a second geometric structure feature corresponding to a pose in the third face image based on a pose feature in the third face image and a pose feature in the first face image; and
obtaining the geometric structure consistency information based on the second geometric structure feature and a three-dimensional geometric structure feature in the third face image.

15. The method according to claim 14, wherein the obtaining the geometric structure consistency information based on the second geometric structure feature and the three-dimensional geometric structure feature in the third face image comprises:
performing normalization on the second geometric structure feature and the three-dimensional geometric structure feature in the third face image, respectively; and
obtaining the geometric structure consistency information using a fully connected network based on normalized features.

16. The method according to claim 1, wherein the performing the image restoration on the third face image comprises:
obtaining an artifact image corresponding to the third face image;
performing degradation on the artifact image to obtain a degraded artifact image as negative samples of a diffusion model used for the image restoration;
performing a diffusion process on the third face image using the diffusion model based on the negative samples, the first face image and the one or more first facial features to obtain first reconstructed features corresponding to the negative samples and second reconstructed features corresponding to the first face image;
obtaining reconstructed features of the third face image based on the first reconstructed features and the second reconstructed features; and
obtaining the fourth face image corresponding to the third face image based on the reconstructed features.

17. An electronic apparatus comprising:
at least one processor;
at least one memory storing computer executable instructions;
wherein the computer executable instructions, when run by the at least one processor, cause the at least one processor to:
obtain a first face image of a subject, which is a high-quality reference face image of the subject with image quality higher than a threshold value,
obtain a second face image of the subject based on the first face image of the subject, the second face image comprising neutral facial features for each part of a face of the subject,
when obtaining a third face image, which is a degraded face image of the subject with image quality lower than the threshold value, obtain one or more personalized facial features of the subject based on the first face image, the second face image and a third face image of the subject,
perform image restoration on the third face image based on the one or more personalized facial features to obtain a fourth face image corresponding to the third face image, and
output the fourth face image corresponding to the third face image.

18. The electronic apparatus of claim 17, wherein the second face image is generated for one or more face regions in the first face image based on a pre-established face part library.

19. The electronic apparatus of claim 17, wherein the at least one processor is further configured to:
obtain one or more first facial features of the subject, based on the first face image, the second face image and the third face image, wherein the one or more first facial features comprise at least one of a three-dimensional geometric structure feature and a texture feature of the face;
obtain one or more second facial features extracted from the third face image, wherein the one or more second facial features comprise at least one of a brightness feature, a color feature, an expression feature, and a pose feature of the face; and
obtain the one or more personalized facial features of the subject based on the one or more first facial features and one or more second facial features.

20. A computer readable storage medium storing instructions that, when executed by at least one processor, cause the at least one processor to perform the method of claim 1.
